(19) United States
(12) Patent Application Publication
(10) Pub. No.: US 2014/0099935 A1
(43) Pub. Date: Apr. 10, 2014

(54) METHOD AND SYSTEM FOR UPDATE OF NETWORK-RELATED INFORMATION, AND ELECTRONIC DEVICE SUPPORTING THE SAME

(71) Applicant: Samsung Electronics Co. Ltd., Suwon-si (KR)

(72) Inventors: Jinsoo HAN, Suwon-si (KR); Hong KIM, Seoul (KR); Sanghyun LEE, Seoul (KR)

(73) Assignee: Samsung Electronics Co. Ltd., Suwon-si (KR)

(21) Appl. No.: 14/047,371

(22) Filed: Oct. 7, 2013

(30) Foreign Application Priority Data
Oct. 8, 2012 (KR) 10-2012-0111175

(51) Int. Cl. H04W 48/16; H04W 88/06

(52) U.S. Cl. CPC H04W 48/16; H04W 88/06
USPC 455/418; 455/550.1; 455/566

(57) ABSTRACT

A system and method for network-related information is provided. In a method for updating network-related information, an electronic device determines whether the network-related information is received from a currently accessed service network, and accesses another service network if the network-related information is not received, and receives the network-related information from the newly accessed service network.

### CROSS-REFERENCE TO RELATED APPLICATION(S)

This application claims the benefit under 35 U.S.C. §119(a) of a Korean patent application filed on Oct. 8, 2012 in the Korean Intellectual Property Office and assigned Serial No. 10-2012-0111175, the entire disclosure of which is hereby incorporated by reference.

### TECHNICAL FIELD

The present disclosure relates to network-related information update technology. More particularly, the present disclosure relates to a method, system, and electronic device for an automatic update of network-related information in a device-located region.

### BACKGROUND

Nowadays a great variety of mobile electronic devices having a communication function, such as smart phones, are increasingly popular due to their high usability and good portability. With a large touch screen and support by hardware and software with the ability to offer various content and services, such mobile electronic devices are now showing dramatic growth.

To use communication services and other applications, mobile electronic devices need to acquire network-related information including appropriate time information. Thus, devices according to the related art acquire and utilize network-related information through various policies of service operators that provide communication services.

However, there are some service operators that fail to provide network-related information. In such cases, users of devices according to the related art have to manually enter a part of network-related information, e.g., time information. This manual input of time information is no matter when a user lives in an environment requiring no change in time information and if an initial input of time information is exact. However, in various situations where a user travels or lives in a region requiring a change in time information, a user needs to often check time information and enter an exact time. Unfortunately, this may cause much inconvenience to a user. Also, if a service operator fails to provide network-related information, an unexpected error may be caused in case where a collection of network-related information is required.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a network-related information update method, system, and electronic device which allow an automatic or easy acquisition of network-related information through a plurality of communication modules.

In accordance with an aspect of the present disclosure, a method for updating network-related information is provided. The method includes determining, by an electronic device, whether the network-related information is received from a currently accessed service network, accessing, by the device, another service network if the network-related information is not received, and receiving the network-related information from the newly accessed service network.

In accordance with another aspect of the present disclosure, a system configured to update network-related information is provided. The system includes a plurality of service networks configured to support device access and to selectively provide the network-related information according to respective policies thereof, and an electronic device configured to register with a specific service network among the service networks and, if the network-related information is not received during the registration, to access another service network so as to receive the network-related information.

In accordance with another aspect of the present disclosure, an electronic device for supporting an update of network-related information is provided. The device includes a plurality of communication modules, and a control unit configured to access a first service network by selecting a predefined communication module among the plurality of communication modules and, if the network-related information is not received from the first service network, to access a second service network by selecting another communication module of the plurality of communication modules so as to receive the network-related information from the second service network.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a schematic diagram illustrating a configuration of a system for an update of network-related information according to an embodiment of the present disclosure;

FIG. 2 is a block diagram illustrating a configuration of an electronic device according to an embodiment of the present disclosure;

FIG. 3 is a block diagram illustrating a configuration of a control unit according to an embodiment of the present disclosure;

FIG. 4 is a flow diagram illustrating a method for an update of network-related information according to an embodiment of the present disclosure;

FIG. 5 is a flow diagram illustrating an actually applied example of the network-related information update method according to an embodiment of the present disclosure;

FIG. 6 shows screenshots of a screen interface in an electronic device supporting a function to update network-related information according to an embodiment of the present disclosure;

FIG. 7 shows a data structure of a network name in network-related information according to an embodiment of the present disclosure; and

FIG. 8 shows a data structure of time information in network-related information according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding, but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but are merely used by the inventor to enable a clear and consistent understanding of the present disclosure. Accordingly, it should be apparent to those skilled in the art that the following description of various embodiments of the present disclosure is provided for illustration purposes only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Furthermore, well known or widely used techniques, elements, structures, and processes may not be described or illustrated in detail to avoid obscuring the essence of the present disclosure. Although the drawings represent various embodiments of the disclosure, the drawings are not necessarily to scale and certain features may be exaggerated or omitted in order to better illustrate and explain the present disclosure.

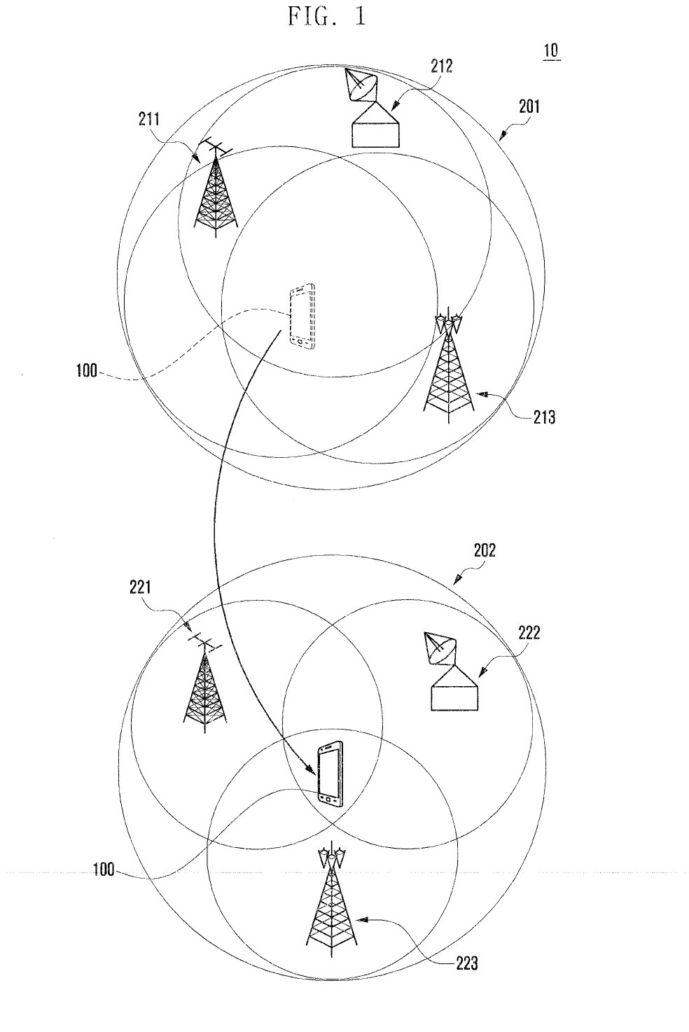

FIG. 1 is a schematic diagram illustrating the configuration of a system for an update of network-related information according to an embodiment of the present disclosure.

Referring to FIG. 1, the network-related information update system 10 may include regional networks 201 and 202 and an electronic device 100.

In the system 10, the device 100 which is located in the first regional network 201 may be moved to the second regional network 202. In this case, the system 10 may enable the device 100 to acquire network-related information from at least one of a plurality of service networks 221, 222, and 223 disposed in the second regional network 202, and then, based on the acquired information, to update network-related information. When registering with one of the service networks 221, 222, and 223, the device 100 may sometimes fail to receive network-related information from a current service network for registration. In this case, the system 10 may enable the device 100 to attempt access to the other service networks and receive network-related information from the accessed service network. Therefore, although the device 100 is not registered with a service network which fails to provide time information, the system 10 may enable the device 100 to automatically update network-related information by instead acquiring network-related information from another service network. In particular, the system 10 may enable the device 100 to automatically collect and update time information in network-related information.

The regional networks 201 and 202 may include the first regional network 201 and the second regional network 202 which have different network-related information. The first regional network 201 may have the first service networks, e.g., three of the first service networks 211, 212, and 213, which are disposed therein and provide respective specific services. For example, the first service network 211 may be a Long Term Evolution (LTE) service network that provides an LTE-based communication service. Additionally, the first service network 212 may be a Universal Mobile Telecommunications System (UMTS) service network that provides an UMTS-based communication service, and the first service network 213 may be a Global System for Communications (GSM) service network that provides a GSM-based communication service. Each of the first service networks 211, 212, and 213 may provide an individual specific communication service to the device 100, depending on communication modules and service types of the device 100. For example, if the device 100 has an LTE communication module, an UMTS communication module, and a GSM communication module, the first service networks 211, 212, and 213 may provide respective specific communication services to the device 100. Some of the first service networks 211, 212, and 213 may fail to provide network-related information. For example, the first service network 211 or 212 may not provide network-related information to the device 100 according to a policy of its service operator, even though supporting a service registration.

Similarly, the second regional network 202 may have second service networks, e.g., three of the second service networks 221, 222, and 223. In this second regional network 202, the second service networks are disposed for a region using network-related information which is different from network-related information provided by the first regional network 201. Namely, just like the first service network 211, the second service network 221 may be the LTE service network but may provide a service based on different network-related information due to a change in region. Similarly, the second service networks 222 and 223 may be the UMTS service network and the GSM service network, respectively, similar to the first service networks 212 and 213. However, the second service networks 222 and 223 may provide their services based on different network-related information in comparison with the first service networks 212 and 213. Further, like the first service networks 211, 212 and 213, any of the second service networks 221, 222 and 223 may not provide network-related information.

The device 100 which is currently located in one of the first and second regional networks 201 and 202 may be registered with one of the service networks disposed in the current regional network and then use a specific communication service provided by the registered service network. If network-related information is not provided to the device 100 that needs new network-related information after being moved from the current regional network to other regional network, the device 100 may send a request for network-related information to other service networks disposed in the located regional network, and receive the requested network-related information. Then the device 100 may extract information used for the operation of the device 100, e.g., time information, from the received network-related information, and based on the extracted information, perform an information update such as an automatic time update. The configuration and operation of the device 100 is described below.

As discussed above, although the device 100 is registered with a service network that fails to provide network-related information to the device 100, the system 10 may enable the device 100 to collect network-related information required for the operation of the device 100 from other service network. Particularly, by allowing collection and update of information automatically or with a minimized input without additional input, the system 10 may enable easy operation of the device 100.

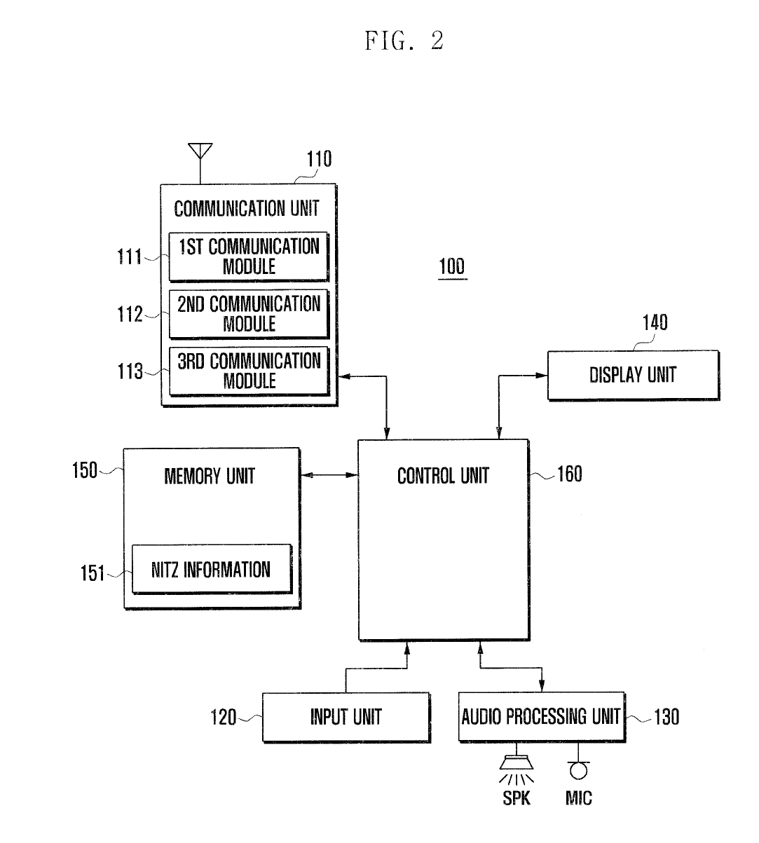

FIG. 2 is a block diagram illustrating a configuration of an electronic device according to an embodiment of the present disclosure.

Referring to FIG. 2, the device 100 may include a communication unit 110, an input unit 120, an audio processing unit 130, a display unit 140, a memory unit 150, and a control unit 160.

The device 100 accesses at least one of the service networks disposed in a specific region via the communication unit 110. If network-related information, e.g., Network Identity and Time Zone (NITZ) information, is not received from the accessed service network, the device 100 may receive NITZ information from another service network that provides a communication service for the same region. In this process, the device 100 may temporarily disable access to the current service network that fails to provide network-related information, and may instead access another service network. Alternatively, depending on a design scheme of the device 100, the device 100 may access the other service network and collect network-related information from that service network while maintaining access to the current service network.

As discussed above, although the currently registered service network fails to provide NITZ information due to a service operator's policy or the like, the device 100 may automatically support a specific service on the basis of various information items contained in NITZ information by collecting NITZ information from another service network. For example, using time information contained in NITZ information, the device 100 may control an automatic time update. As used herein, NITZ information may include time information, Greenwich Mean Time (GMT) information, Daylight Saving Time (DST) information, network name information, and the like.

The communication unit 110 may have a plurality of communication modules 111, 112, and 113. Although three communication modules are illustrated as included in the communication unit 110, this is exemplary only and not to be considered as a limitation of the disclosure. The communication unit 110 may have two, four or more communication modules. Using respective communication modules, the communication unit 110 may support a search for and access to service networks based on different network Radio Access Technology (RAT), and may also support a reception of network-related information from a specific service network under the control of the control unit 160. Hereinafter, it is supposed that the first communication module 111 is designed to have access to the first service network 211 and the second service network 221. Similarly, it is supposed that the second communication module 112 is designed to have access to the first service network 212 and the second service network 222, and the third communication module 113 is designed to have access to the first service network 213 and the second service network 223. The first communication module 111 may be a LTE communication module, the second communication module 112 may be a UMTS communication module, and the third communication module 113 may be a GSM communication module. However, this is exemplary only and not to be considered as a limitation of the disclosure. Each of the above-discussed communication modules may be equipped in the form of being accessible to a specific service network among various service networks.

The communication modules 111, 112, and 113 in the communication unit 110 may have respective service priorities. For example, the device 100 may be designed to perform network registration using the first communication module 111 when moving to a new regional network with power supplied. Alternatively, depending on the user's setting or the device designer's design, the device 100 may perform network registration by using, first of all, the second communication module 112. Accordingly, when the device 100 performs network registration using a specific communication module after being located in a specific regional network, the device 100 may sometimes fail to receive network-related information due to a relevant service network policy. In this case, the communication unit 110 may receive network-related information from at least one of other communication modules unconnected with current network registration under the control of the control unit 160, and then provide the received network-related information to the control unit 160.

The input unit 120 creates various input signals for the operation of the device 100. The input unit 120 may include a home key, a side key, a keypad, and the like. If the display unit 140 supports an input function, the input unit 120 may be formed as a touch screen or a touch panel. Additionally, the input unit 120 may be formed as a stylus pen, an electromagnetic induction pen, or any other equivalent. The input unit 120 may create an input signal for requesting a supply of power and various input signals for supporting specific user function the device 100 can provide. The input unit 120 may create an input signal for instructing an update of network-related information in response to user's manipulation. The device 100 may provide a menu or icon for allowing a user to instruct an update of network-related information, and the input unit 120 may provide an input function to select such a menu or icon. If the device 100 is designed to automatically provide a function to update network-related information, such a menu, icon or associated routines may be omitted.

The audio processing unit 130 includes a speaker SPK to output various audio data in connection with the operation of the device 100. If the device 100 supports a call function or a recording function, the audio processing unit 130 may further include a microphone MIC to collect audio data. As discussed above, when performing registration at a specific service network after being located in a certain regional network, the device 100 may fail to receive network-related information from that service network. In this case, the audio processing unit 130 may output a feedback sound to indicate a failure in reception of network-related information under the control of the control unit 160. Additionally, if network-related information is received from another service network, the audio processing unit 130 may output a feedback sound or sound effects regarding reception and use of such network-related information. Also, if network-related information is not received from all service networks in a currently located regional network, the audio processing unit 130 may output a suitable feedback sound or sound effects. The output of feedback sounds or sound effects from the audio processing unit 130 may be omitted or removed, depending on user's setting or designer's intention.

The display unit 140 may display various screens used for the operation of the device 100. For example, if an update of time information occurs on the basis of network-related information collected through the communication unit 110, the display unit 140 may provide a screen suitable for the update. Additionally, depending on design types, the display unit 140 may provide the received network-related information through a screen. To support an input function as well as a display function, the display unit 140 may be configured to have both a touch panel and a display panel, and may also define available regions of the touch panel corresponding to various virtual key maps outputted on the display panel. The display unit 140 may provide at least one of a mode support screen for setting automatically or manually an update of network-related information, a screen for instructing an update of network-related information in case of a manual setting, and a screen associated with a process of automatically performing an update of network-related information in case of an automatic setting. Various screen interfaces provided through the display unit 140 will be described later with reference to drawings.

The memory unit 150 may store a variety of programs used for the operation of the device 100, programs associated with a variety of functions supported by the device 100, and data in connection with such programs. The memory unit 150 may store network-related information 151 for an update of network-related information.

As described above, the network-related information 151 may be NITZ information and may need to be updated due to a movement between regional networks. For example, the device 100 which is located in the first regional network 201 and registered with the first service network 211 may move to the second regional network 202 and be newly registered with the second service network 221. Then the memory unit 150 which stores network-related information provided by the first service network 211 may perform an update to network-related information provided by the second service network 221. If the second service network 221 fails to provide network-related information due to a policy of a service operator, the memory unit 150 may receive network-related information from at least one of other second service networks 222 and 223 and, based on the received information, perform an update of the network-related information 151. The memory unit 150 may support an automatic update of a part of the network-related information, e.g., time information only.

The memory unit 150 may store information about a specific service network at which the device 100 performs registration for a communication service after being disposed in a specific regional network. Information about the registered service network may be used for a routine change to the registered initial service network after network-related information is received and updated.

The control unit 160 may support the whole signal flows and data processing, delivery and saving management in connection with a control for the operation of the device 100. For an update of network-related information, the control unit 160 may support a control for the communication unit 110, a reception and update of information, a control for activation of a service network, and the like.

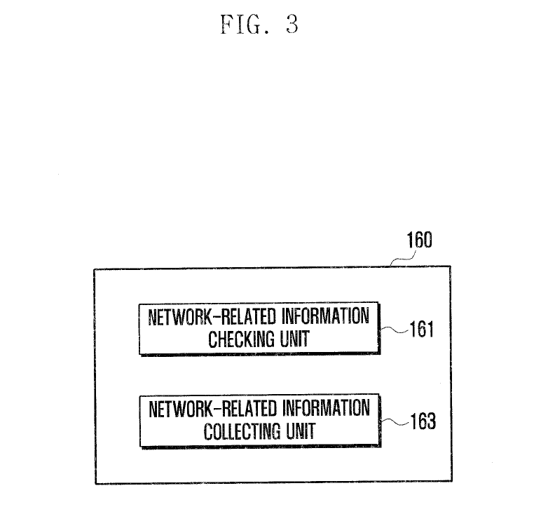

FIG. 3 is a block diagram illustrating the configuration of a control unit according to an embodiment of the present disclosure.

Referring to FIG. 3, the control unit 160 may include a network-related information checking unit 161 and a network-related information collecting unit 163.

The network-related information checking unit 161 supports registration with a certain service network belonging to a specific regional network in which the device 100 is disposed and determines whether network-related information is received from the service network. When the device 100 is disposed in a certain service network, the network-related information checking unit 161 may supply electric power to one of the communication modules contained in the communication unit 110, e.g., to the first communication module 111, and perform a surrounding scan process using the first communication module 111. Also, if the first service network 211 is available for the operation of the first communication module 111, the network-related information checking unit 161 may control a registration process with the first service network 211. In this registration process, the network-related information checking unit 161 determines whether network-related information defining a network, e.g., NITZ information is included in information provided by the first service network 211.

If the first service network 211 provides NITZ information, the network-related information checking unit 161 may provide the NITZ information to the network-related information collecting unit 163. If the first service network 211 does not provide NITZ information, the network-related information checking unit 161 may notify the network-related information collecting unit 163 that the currently registered first service network 211 fails to provide NITZ information. The network-related information checking unit 161 may perform the above-discussed process of checking network-related information when access to a certain service network is performed after power turn-on and activation of the communication unit 110 or when access to a new service network is performed according to a move from the first regional network 201 to the second regional network 202.

The network-related information collecting unit 163 may perform a collection of network-related information when receiving, from the network-related information checking unit 161, a notification that network-related information, e.g., NITZ information, is not received from a currently registered service network, or when a request for collecting network-related information is received from the input unit 120. In this process, the network-related information collecting unit 163 collects network-related information by using at least one of some communication modules other than a specific communication module performing registration at a service network among the communication modules 111, 112, and 113 contained in the communication unit 110. In this case, if two or more such communication modules are present, the network-related information collecting unit 163 may select, pursuant to a predefined rule or at random, one of the two or more communication modules and then collect network-related information by using the selected module.

For example, if network-related information is not received while the first communication module 111 is registered with the first service network 211, the network-related information collecting unit 163 may receive network-related information from another first service network 212 by using the second communication module 112 pursuant to a predefined rule. The network-related information collecting unit 163 may activate the second communication module 112, perform a search for and access to another first service network 212, and receive network-related information from another first service network 212. In this case, if another first service network 212 fails to provide network-related information, the network-related information checking unit 161 may notify this failure to the network-related information collecting unit 163. The network-related information collecting unit 163 may then activate the third communication module 113, perform a search for and access to the other first service network 213, and receive network-related information from the other first service network 213. If none of the service networks accessed by the respective communication modules 111, 112 and 113 provide network-related information, then the network-related information collecting unit 163 may support an output of a message indicating a failure in collecting network-related information.

If network-related information is successfully collected from a service network, the network-related information collecting unit 163 may update time information by using information such as time information and network name information contained in the network-related information or use such information in applications provided by the device 100. Additionally, the network-related information collecting unit 163 may utilize an initially registered service network after a collection of network-related information. The network-related information collecting unit 163 may support the operation of the first communication module 111 while deactivating the second communication module 112 or the third communication module 113 which is used for a collection of network-related information.

As described above, if a registered service network fails to provide network-related information, the system 10 may collect network-related information from another neighbor service network and then perform functions of the device 100 by using the collected network-related information.

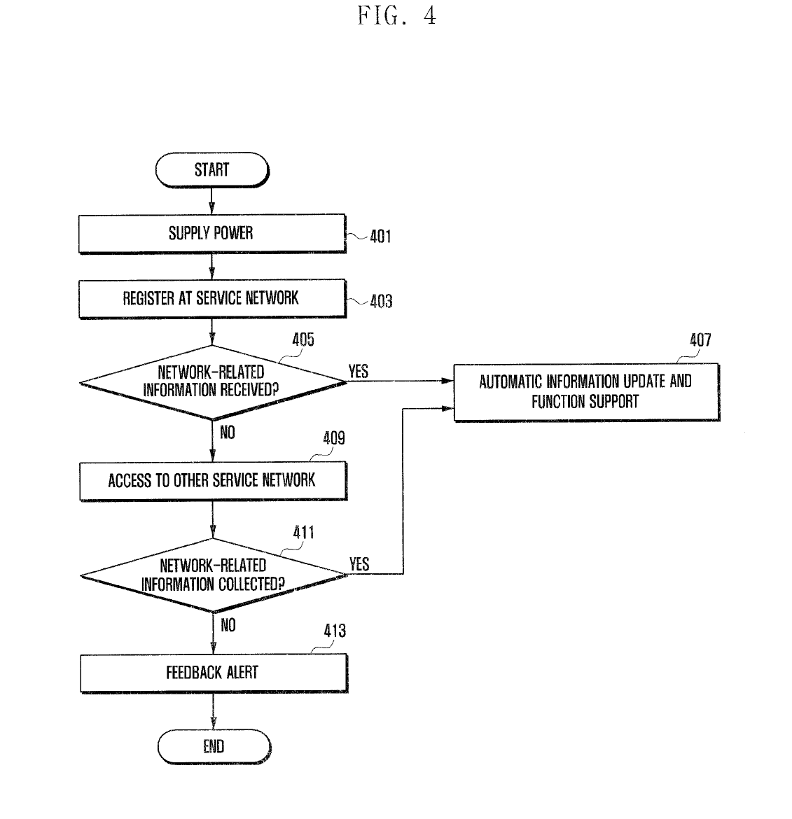

FIG. 4 is a flow diagram illustrating a method for an update of network-related information according to an embodiment of the present disclosure.

Referring to FIG. 4, when electric power is supplied to the device 100 at operation 401, the control unit 160 may, if necessary, register with a service network at operation 403. The control unit 160 may service network registration process when the communication unit 110 is turned on, when the device 100 enters into a new service network, or at any other suitable time.

At operation 405, the control unit 160 may determine whether network-related information is received. The network-related information refers to information provided by a service network with which the device 100 is registered, and may not be provided for various reasons, such as a policy of a service operator. If network-related information is successfully received from a service network at operation 405, the control unit 160 may perform an automatic update of network-related information and a support of associated functions at operation 407. For example, using network name information or time information contained in network-related information, the control unit 160 may support a particular user function or perform a time adjustment.

If no network-related information is received at operation 405, the control unit 160 may access another service network at operation 409 and then at operation 411 determine again whether network-related information is collected. If a collection of network-related information is successfully received from the another service network, the control unit 160 may perform an automatic update of network-related information and a support of associated functions at operation 407.

If network-related information is not received from the another service network, the control unit 160 may issue at operation 413 a feedback alert that indicates a failure in the collection of network-related information. For example, the control unit 160 may control an output of a network-related information collection failure message through at least one of the audio processing unit 130 and the display unit 140.

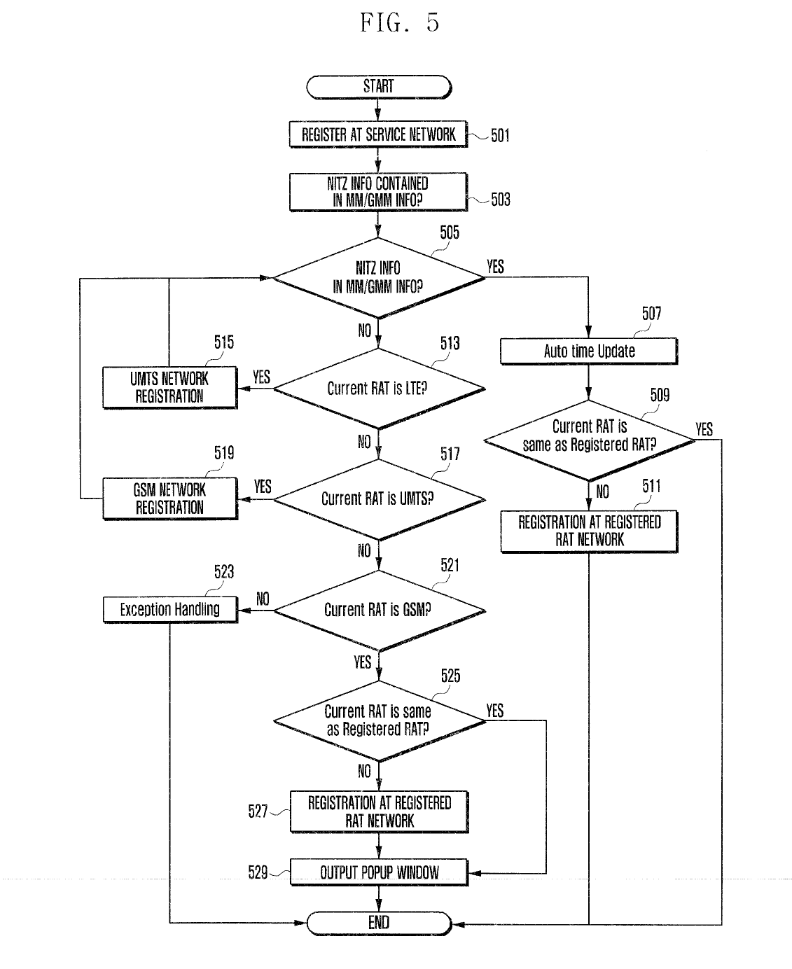

FIG. 5 is a flow diagram illustrating an actually applied example of the network-related information update method according to an embodiment of the present disclosure. FIG. 5 shows an automatic update of time information among network-related information in a case where the device 100 has access to the LTE network, the UMTS network, the GSM network, and the like.

Referring to FIG. 5, the device 100 performs registration with a specific service network in accordance with a predetermined rule at operation 501. At operation 503, a current RAT (Radio Access Technology) may be a registered RAT.

At operation 505, the device 100 determines whether NITZ information is contained in Mobility Management/GPRS-MM (MM/GMM) information. If NITZ information is contained in the MM/GMM information, the device 100 performs an automatic time update at operation 507. At operation 509, the device 100 determines whether the current RAT is identical to the registered RAT, and if identical, may terminate a function to update network-related information. If the current RAT is different from the registered RAT at operation 509, the device 100 registers with the registered RAT network at operation 511 and then may terminate a function to update network-related information.

If NITZ information is not contained in MM/GMM information at operation 505, the device 100 may determine at operation 513 whether the current RAT is LTE. The device 100 may temporarily disable access to the current service network which does not provide NITZ information.

If the current RAT is LTE, the device 100 performs UMTS network registration at operation 515 and then may return to operation 505. If the current RAT is not LTE at operation 513, the device 100 determines whether the current RAT is UMTS at operation 517. If so, the device 100 performs GSM network registration at operation 519 and then may return to operation 505. If the current RAT is not UMTS at operation 517, the device 100 may determine whether the current RAT is GSM at operation 521. If the current RAT is not GSM, the device 100 performs exception handling at operation 523 and then may terminate a function to update network-related information. Exception handling may refer to operations performed in response to errors.

If the current RAT is GSM at operation 521, the device 100 determines at operation 525 whether the current RAT is the registered RAT. If the current RAT is not the registered RAT, the device 100 registers with the registered RAT network at operation 527 (i.e., performs re-access to the temporarily removed RAT network), and then may output a popup window indicating a failure in a collection of network-related information at operation 529. If the current RAT is the registered RAT at operation 525, the device 100 skips operation 527, outputs the popup window indicating a failure in a collection of network-related information in operation 529, and then may terminate a function to update network-related information.

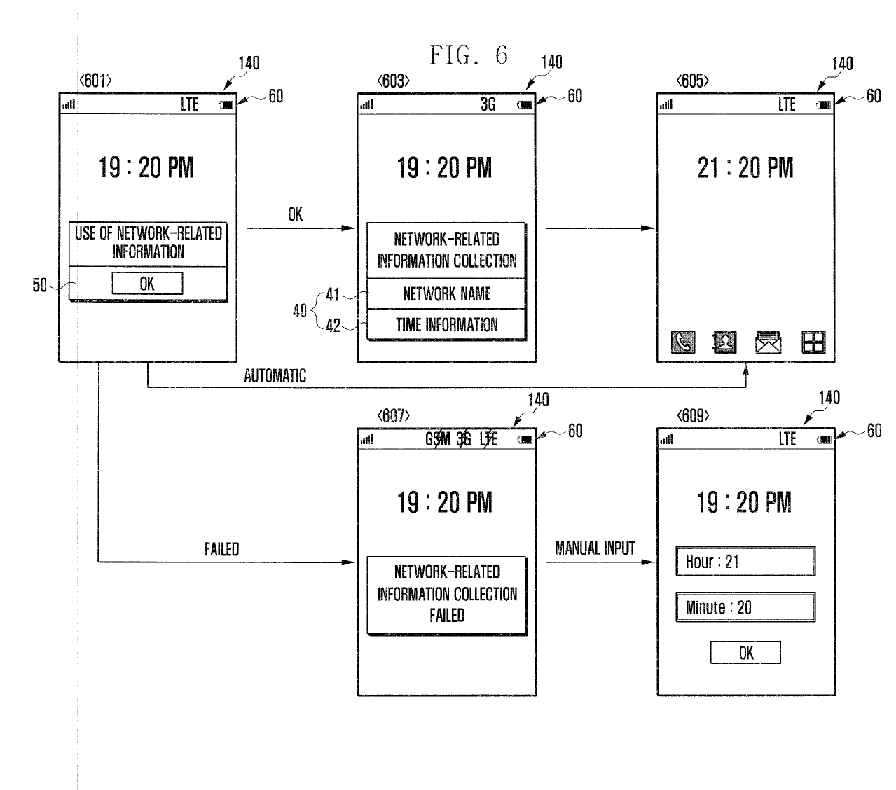

FIG. 6 shows screenshots of a screen interface in an electronic device supporting a function to update network-related information according to an embodiment of the present disclosure.

Referring to FIG. 6, the device 100 may use network-related information when there is a history of access to a service network and when network-related information is received from the accessed service network. In this case, as shown in screenshot 601, the display unit 140 may obtain time information contained in network-related information and then output time information synchronized with the time information on the screen. When access to a new service network is performed due to a regional move of the device 100, the device 100 may perform new service network registration. If this service network fails to provide network-related information, the display unit 140 may output an indication item 50 for indicating the use of network-related information as shown in screenshot 601. This output of the indication item 50 may be performed when a network-related information update function is selected as a manual mode. In case of an automatic mode, the output of the indication item 50 may be skipped, or a screen for a collection of network-related information may automatically appear as given time passes after a display of the above indication item 50. If the user selects the indication item 50, the device 100 may access another service network and collect network-related information. As the control unit 160 collects network-related information, the display unit 140 may output a feedback message associated with a collection of network-related information as shown in screenshot 603. The control unit 160 may control the output of an item 40 of the collected network-related information as shown. The display unit 140 may display a network name 41 and time information 42 in the network-related information item 40. The above output of the feedback message and the network-related information item 40 may be skipped in case of an automatic mode.

Meanwhile, the control unit 160 extracts time information from network-related information and, based on the extracted time information, updates time information of the device 100. The display unit 140 may output the updated time information as shown in screenshot 605. Additionally, in screenshots 601 to 605, the display unit 140 may output an indicator for indicating a currently registered or accessed service network and communication module at an indicator region 60. For example, if the device 100 is set by default to have access to the LTE service network, the control unit 160 may control an output of “LTE” indicator at the indicator region 60 as shown in screenshot 601. Also, when controlling access to another service network, e.g., a 3G network, for a collection of network-related information, the control unit 160 may control an output of “3G” indicator at the indicator region 60 as shown in screenshot 603. Similarly, when access to another network such as GSM service network for a collection of network-related information is performed, the control unit 160 may support an output of “GSM” indicator at the indicator region 60. The control unit 160 may terminate or maintain access to a previously accessed service network, depending on a predefined rule. Additionally, after a collection of network-related information is completed, the control unit 160 may perform re-access to a predefined service network, e.g., “LTE” network, and support an output of an associated indicator “LTE” at the indicator region 60.

If collection of network-related information fails after attempting the collection using all of the communication modules 111, 112, and 113 contained in the communication unit 110, the device 100 may output a feedback message indicating a failure in a collection of network-related information as shown in screenshot 607. The control unit 160 may output indicators indicating a failure in a collection of network-related information at the indicator region 60 as shown. Thereafter, if any input event for adjusting time information is received from a user, the device 100 may output a screen for adjusting time information to the display unit 140 as shown in screenshot 609. Even though a collection of network-related information fails, the control unit 160 may access a predefined service network, e.g., LTE network, and output a related “LTE” indicator at the indicator region 60 as shown in screenshot 609. Indicators outputted at the indicator region 60 may be varied in the form of indicating a network access state.

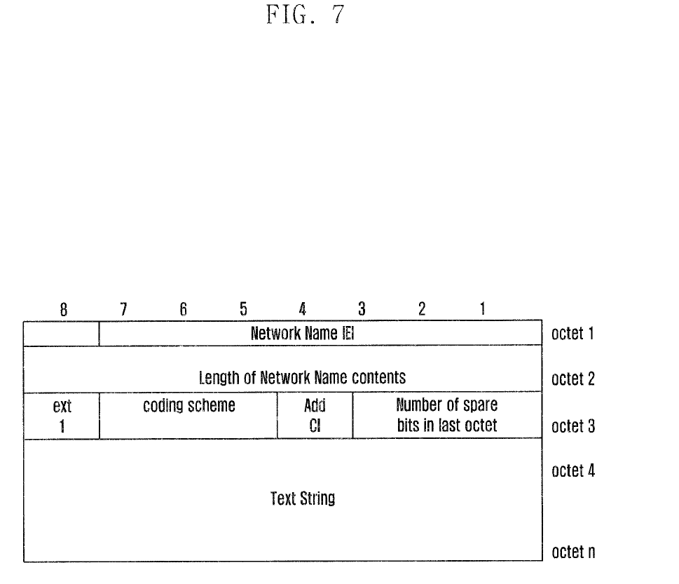

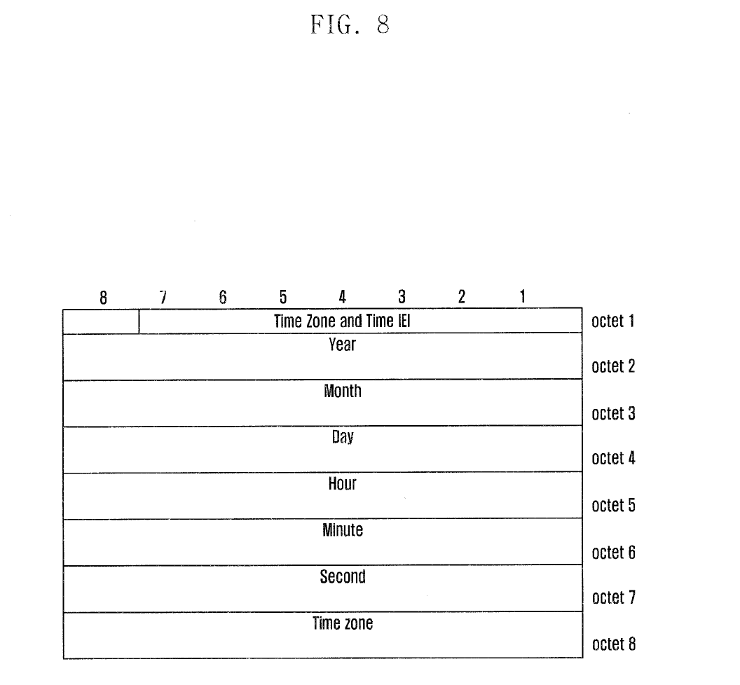

FIG. 7 shows a data structure of a network name in network-related information according to an embodiment of the present disclosure. FIG. 8 shows a data structure of time information in network-related information according to an embodiment of the present disclosure.

Referring to FIGS. 7, and 8, the network name may have a structure of Network Name IEI [octet 1], Length of Network Name contents [octet 2], ext 1, coding scheme, Add CI, Number of spare bits in last octet [octet 3], and Text String [octet 4˜N]. Additionally, as shown in FIG. 8, the time information may have a structure of Time Zone and Time JET [octet 1], Year [octet 2], Month [octet 3], Day [octet 4], Hour [octet 5], Minute [octet 6], Second [octet 7], and Time Zone [octet 8].

As described above, the device 100 may collect, automatically or at the user's request, network-related information available for the same region or coverage by accessing another service network even though network-related information is not received from the currently accessed service network. Accordingly, the device 100 may support user functions without errors on the basis of information required for operation thereof.

According to a digital convergence tendency today, the above-discussed electronic device 100 may essentially or selectively further include additional elements, such as a short-range communication module, a wired or wireless communication interface, an Internet communication module, a digital broadcast receiving module, and the like. Meanwhile, as will be understood by those skilled in the art, some of the above-mentioned elements in the device 100 may be omitted or replaced with another element.

Additionally, the electronic device 100 according to embodiments of this disclosure may be applied to various types of mobile communication terminals, such as a cellular phone, a smart phone, a tablet PC, a handheld PC, a Portable Multimedia Player (PMP), a Personal Digital Assistant (PDA), a notebook, a portable game console, and the like.

While the present disclosure has been shown and described with reference to various embodiments thereof, it will be understood by those skilled in the art that various changes in form and details may be made therein without departing from the spirit and scope of the as defined by the appended claims and their equivalents.

What is claimed is:

1. A method for updating network-related information, the method comprising:
determining, by an electronic device, whether the network-related information is received from a currently accessed service network;
accessing, by the device, another service network if the network-related information is not received; and
receiving the network-related information from the newly accessed service network.

2. The method of claim 1, further comprising at least one of:
terminating, by the device, access to the currently accessed service network before accessing the other service network; and
re-accessing, by the device, the initially accessed service network after receiving the network-related information.

3. The method of claim 1, further comprising:
updating, by the device, stored network-related information based on the received network-related information,
wherein the updating of the stored network-related information includes:
extracting time information from the received network-related information; and
updating time information of the device based on the extracted time information.

4. The method of claim 1, wherein the accessing of the other network comprises:
accessing the other network via a different communication module than a communication module supporting the currently accessed service network among communication modules contained in the device.

5. The method of claim 4, further comprising:
outputting a feedback message to a display unit of the device in response to a failure in receiving the network-related information through all the communication modules contained in the device.

6. The method of claim 5, further comprising:
performing an initial service network access after a failure in receiving the network-related information.

7. The method of claim 4, wherein the accessing of the other networking comprises:
selecting another communication module of the communication modules contained in the device based on a predefined priority; and
accessing a specific service network via the selected communication module.

8. The method of claim 1, wherein the network-related information includes at least one of network name information and time information.

9. A system configured to update network-related information, the system comprising:
a plurality of service networks configured to support device access and to selectively provide the network-related information according to respective policies of the plurality of service networks; and
an electronic device configured to register with a specific service network among the service networks and, if the network-related information is not received during the registration, to access another service network so as to receive the network-related information.

10. The system of claim 9, wherein the device includes a plurality of communication modules, each of which is configured to access a corresponding one of the service networks.

11. An electronic device for supporting an update of network-related information, the device comprising:
a plurality of communication modules; and
a control unit configured to access a first service network by selecting a predefined communication module among the plurality of communication modules and, if the network-related information is not received from the first service network, to access a second service network by selecting another communication module of the plurality of communication modules so as to receive the network-related information from the second service network.

12. The device of claim 11, further comprising:
a display unit configured to display at least one of a state where the network-related information is not received, and a state where access to the second service network is performed and the network-related information is received from the second service network.

13. The device of claim 11, wherein the control unit is further configured to temporarily disable access to the first service network.

14. The device of claim 13, wherein the control unit is further configured to restore access to the first service network after the network-related information is received.

15. The device of claim 11, wherein the control unit is further configured to extract time information from the received network-related information, and to update time information of the device based on the extracted time information.

16. The device of claim 11, wherein the control unit is further configured to access another service network in response to a failure in receiving the network-related information from the second service network and to receive the network-related information from the other service network.

17. The device of claim 16, wherein the control unit is further configured to output a feedback message to a display unit in response to the failure in receiving the network-related information through the plurality of communication modules.

18. The device of claim 17, wherein the control unit is further configured to restore access to the first service network after the failure in receiving the network-related information.

19. The device of claim 11, wherein the control unit is further configured to select another communication module among the communication modules pursuant to a predefined priority, and to perform access to the second service network via the selected communication module.

20. The device of claim 11, wherein the network-related information includes at least one of network name information and time information.
